(19) United States
(12) Patent Application Publication
(10) Pub. No.: US 2026/0094138 A1
(43) Pub. Date: Apr. 2, 2026

(54) PROVISIONING OF DIGITAL STORED VALUE STRUCTURE IN SECURE LOCATION

(71) Applicant: Fiserv, Inc., Milwaukee, WI (US)

(72) Inventors: Manush Farhang, New York City, NY (US); Sridher Swaminathan, Omaha, NE (US)

(73) Assignee: Fiserv, Inc., Milwaukee, WI (US)

(21) Appl. No.: 19/081,737

(22) Filed: Mar. 17, 2025

Related U.S. Application Data
(60) Provisional application No. 63/700,609, filed on Sep. 27, 2024.

(51) Int. Cl. G06Q 20/10; G06Q 20/06; G06Q 20/36; G06Q 20/40

(52) U.S. Cl. CPC G06Q 20/105; G06Q 20/06; G06Q 20/363; G06Q 20/4014

(57) ABSTRACT

Implementations and examples described herein provide for integrating gift cards and gift card transactions into payment flows that include general payment networks, providing the functionality of closed-loop gift card systems within the wider payment networks and allowing for the use of gift cards with additional payment methods.

### CROSS-REFERENCE TO RELATED APPLICATIONS

This application claims priority to US Provisional Application No. 63/700,609, filed Sep. 27, 2024, which application is incorporated herein by reference in its entirety.

### BACKGROUND

Credit cards and debit cards can be loaded into a hardware secure element or secure memory or a combination thereof of a mobile device secure location to allow for near field communication (NFC) payments and integrated online payments.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

Aspects of the present disclosure are directed to loading prepaid transaction instruments, such as gift cards, into the secure location of a mobile device to allow for NFC payments and integrated online and in-app payments. This reduces payment friction by allowing gift cards to be used, stored, and processed the same as credit or debit cards. Examples and embodiments described herein provide for a gift card server that provides the functionality of a closed-loop gift card system within existing payment networks. This allows multiple merchants to consolidate the processing of their gift cards within the gift card server to allow gift cards to be provisioned within digital wallets and for gift card transactions to be routed within existing payment networks. This provides a technical solution to the technical problem of gift cards not being compatible with NFC payments or digital payments.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is a block diagram of a system implementing a conventional closed-loop process for using a prepaid card in a transaction.

FIG. 2 is a block diagram of an example system for using prepaid cards that are provisioned to a secure element in a mobile device.

FIG. 3 is a block diagram of an example system for provisioning prepaid cards to a secure location in a mobile device.

FIG. 4 is a block diagram of an example system for executing transactions using prepaid cards that are provisioned to a secure location in a mobile device.

FIG. 5 is a flow diagram illustrating operations of an example method for provisioning prepaid cards to a secure location in a mobile device.

FIG. 6 is a flow diagram illustrating operations of an example method for executing transactions using prepaid cards that are provisioned to a secure location in a mobile device.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

Aspects of the present disclosure relate to provisioning gift cards into a secure location of a mobile device for use in a digital wallet. Conventional systems process gift cards within closed-loop systems, where a merchant maintains a ledger of its gift cards and the balance of each gift card, where during a gift card transaction, the merchant references the ledger to determine how much to deduct from the ledger and whether additional funds are needed to complete the transaction. These closed-loop systems do not connect to wider payment networks and are incompatible with payment methods that connect to the wider payment networks, such as mobile device NFC payments, in-app purchases, and integrated online payments. The technical problem of gift card incompatibility with payment methods causes transaction friction for consumers, as they have to use a physical gift card, an image of a gift card, a bar code from a gift card, or a QR code from a gift card. Challenges facing merchants include: gift cards cannot be used for payment in digital wallets, digital QR codes cannot be redeemed in-store without barcode reader, barcode/QR readers are not always functional or available at time of purchase, the use of QR codes is slower process relative to tap to pay, fraud is a high concern across the industry for physical, plastic transaction cards, friction-the use of gift cards requires customers to go outside of the native experience to reload, first party wallets lack functionality for end-to-end user experience, and as customers using gift cards are anonymous, gift card fraud, there is no opportunity to track purchases or to integrate gift cards into loyalty programs. Challenges facing customers include: customers can only use physical gift cards (they do not have digital gift card), although pictures of QR codes can be used, customers cannot use physical cards in online ordering, customers face friction to activate and to carry physical cards for redemption, and app users cannot combine their rewards and gift cards for redemption/payment natively in the app wallet.

Implementations and examples described herein solve this technical problem by integrating gift cards and gift card transactions into wider payment networks by provisioning gift cards into digital wallets (i.e., into the secure locations of digital wallets), providing the functionality of closed-loop gift card systems within the wider payment networks and allowing for the use of gift cards with additional payment methods. One implementation discussed herein includes an aggregated prepaid card system that maintains a ledger for multiple different merchants and their respective gift cards. The aggregated prepaid card system can function as an issuer system within a payment flow to authorize gift card transactions based on available balance, domain restrictions, and other factors. The aggregated prepaid card system can function within existing transaction flows, allowing for the use of gift cards within payment methods that were previously restricted to credit and debit cards.

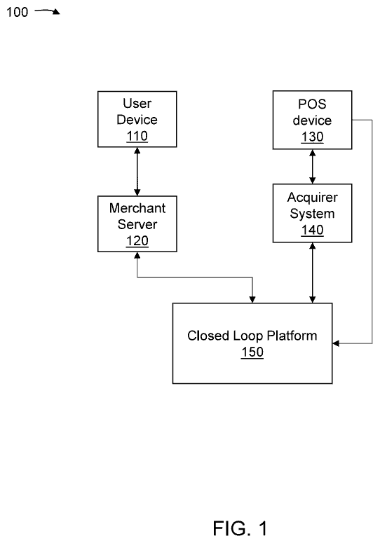

FIG. 1 is a block diagram of a system 100 implementing a conventional closed-loop process for using a prepaid card in a transaction. The system 100 includes a user device 110, a merchant server 120, a point-of-sale device 130, an acquirer system 140, and a closed loop platform 150. The user device 110 can be a mobile device, a personal computer, a tablet, or other computing device. When a user buys a gift card (i.e., prepaid transaction card), the gift card is activated, and a value of the gift card is stored on the closed loop platform 150. When the gift card is bought in an online transaction, the user device 110 transmits a gift card request to the merchant server 120, the merchant server communicates with a payment network to obtain payment, and transmits a notification of purchase to the close loop platform 150 for the closed loop platform to record the value of the purchased gift card. When the gift card is bought using the POS device 130, the POS device 130 transmits details of the gift card to the closed loop platform 150 upon purchase of the gift card to store the value of the gift card at the closed loop platform 150.

During online transactions, the user device 110 transmits gift card details including a primary account number (PAN) to the merchant server 120 and the merchant server 120 sends the gift card details to the closed loop platform 150 to determine whether the gift card has sufficient funds for the transaction. If the gift card has sufficient funds, the closed loop platform 150 transmits an authorization to the merchant server 120 and updates the value of the gift card based on the transaction. During transactions at the POS device 130 using a gift card, the POS device 130 sends the gift card details to the closed loop platform 150 or to the acquirer system 140 which sends the gift card details to the closed loop platform 150. Similar to the online transactions, the closed loop platform verifies that the gift card has sufficient funds, transmits an authorization, and updates the value of the gift card.

The system 100 is limited to online transactions where a user enters in the gift card details and in-person transactions where the POS device 130 scans the gift card details (e.g., from bar code or magnetic stripe). Thus, using the system 100, gift cards are excluded from transactions using secure locations in digital wallets, such as APPLE PAY, GOOGLE WALLET, and SAMSUNG WALLET.

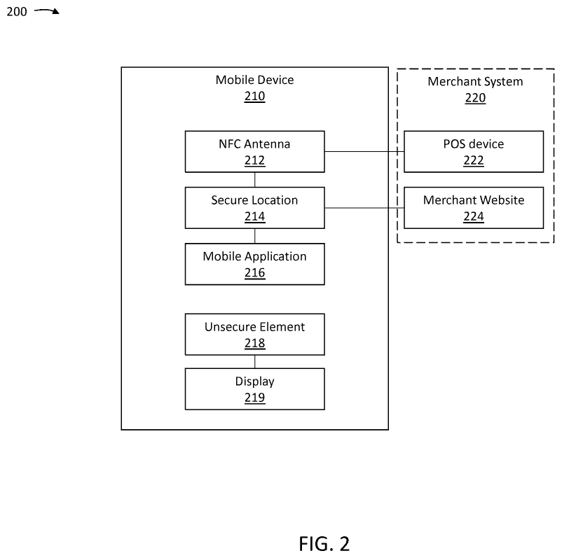

FIG. 2 is a block diagram of an example system 200 for using prepaid cards that are provisioned to a secure element in a mobile device. The system 200 includes a mobile device 210, and a merchant system 220. The merchant system 220 includes a POS device 222 and a merchant website 224. The mobile device 210 includes an NFC antenna 212, a secure location 214, a mobile application 216, an unsecure element 218, and a display 219. Conventional systems only allow for prepaid cards (e.g., gift cards) to be stored in the unsecure element 218. As such, the prepaid cards are not accessible to the mobile application 216 or the NFC antenna 212. The NFC antenna 212 can be used to perform NFC transactions (e.g., tap transactions) at the POS device 212 using transaction cards stored in the secure location 214 and the secure location 214 can be used to perform transactions originating in mobile applications 216 or on a merchant website 224. The secure location 214 can be implemented using hardware (e.g., secure memory chip), software (e.g., secure memory location), and/or a combination of hardware and software. However, prepaid cards stored in the unsecure element 218 can only be used by displaying the prepaid cards on the display 219 and scanning the prepaid card using a scanner of the POS device. Thus, provisioning prepaid cards into the secure location 214 allows for use of a wider variety of payment methods with lower transaction friction. However, prepaid cards cannot be provisioned into the secure location 214 in conventional systems, as the prepaid cards are associated only with a closed-loop gift card system. However, by generating a token for a prepaid card that complies with payment token specifications, the token can be provisioned into the secure location 214. During a transaction, the token can be used similar to other payment tokens, where the payment token is routed to an aggregated prepaid card system that functions as a system of record for prepaid cards for a plurality of merchants.

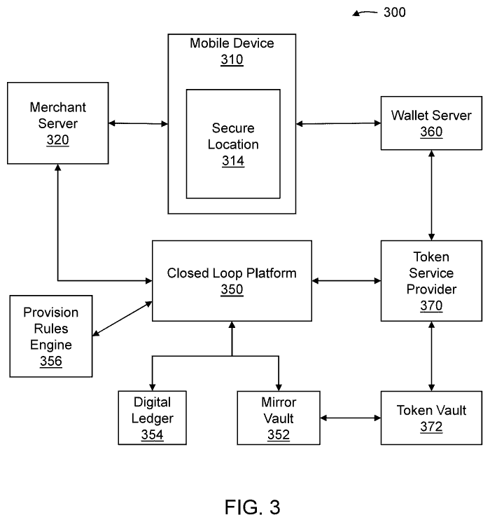

FIG. 3 is a block diagram of an example system 300 for provisioning prepaid cards to a secure location in a mobile device. The system 300 includes a mobile device 310, a merchant server 320, a closed loop platform 350, a mirror vault 352, a digital ledger 354, a provision rules engine 356, a wallet server 360, a token service provider (TSP) 370, and a token vault 372. In some implementations, the mirror vault 352, the digital ledger 354, and the provision rules engine 356 are part of the closed loop platform 350. The mobile device 310 includes a secure location 314. The system 300 operates to provision a prepaid card (e.g., gift card) to the secure location 314 of the mobile device 310 such that the prepaid card can be used in digital wallet transactions and integrated application transactions.

When a prepaid card is purchased, details of the prepaid card such as a primary account number and an amount are provided from the merchant server 320 to the closed loop platform 350. The closed loop platform 350 stores the details of the prepaid card in the digital ledger 354. In an example, the digital ledger 354 includes primary account numbers of prepaid cards associated with amounts/values of the prepaid cards. In some implementations, the digital ledger 354 includes indications as to whether a prepaid card is activated and/or provisioned to the secure location 314.

The mobile device 310 obtains details of a prepaid card. The mobile device 310 can scan the prepaid card to obtain the details (e.g., primary account number) of the prepaid card, a user can enter the details of the prepaid card, or the mobile device 310 can scan a QR code to obtain the details of the prepaid card. In some implementations, the mobile device 310 receives the details of the prepaid card from the merchant server 320. In an example, a user uses the mobile device 310 to purchase the prepaid card (e.g., digital gift card) from a website of the merchant, causing the merchant server 320 to transmit the details of the prepaid card to the mobile device 310.

The mobile device 310 transmits the details of the prepaid card to the wallet server 360, which transmits the details of the prepaid card to the TSP 370. The TSP 370 tokenizes the details of the prepaid card to generate a token (e.g., a device primary account number (DPAN)) and stores the token in the token vault 372. The TSP 370 transmits the token to the wallet server 360 and the wallet server stores the token in the secure location 314 of the mobile device 310. The secure location 314 may be implemented using hardware and/or software, as discussed herein. The secure location 314 may be part of a digital wallet of the mobile device 310 corresponding to the wallet server 360.

In some implementations, the mobile device 310 does not receive the details of the prepaid card. In an example, the merchant server 320 sends an indication of a purchase of the prepaid card to the closed loop platform 350 as part of a provision request. The closed loop platform 350 can transmit a tokenization request to the TSP 370 for the TSP 370 to tokenize the PAN of the prepaid card and transmit the resulting token to the wallet server 360 for storage in the secure location 314. In an example, a user purchases the prepaid card online with a request to provision to the secure location 314 of the mobile device 310, causing the closed loop platform 350 to initiate provisioning of the prepaid card to the secure location 314 by requesting tokenization from the TSP 370. In an example, the mobile device 310 receives a link, text message, or email to provision the prepaid card from another mobile device, where the link, text message, or email allows the user to initiate provisioning of the prepaid card.

The TSP 370 provides the details of the prepaid card and the generated token (e.g., DPAN) to the closed loop platform 350. The closed loop platform 350 stores the details of the prepaid card and the generated token to the mirror vault 352. The mirror vault 352 mirrors a mapping of card details to tokens stored in the token vault 372. The mirror vault 352 is periodically synchronized with the token vault 372 to ensure that the mirror vault 352 mirrors the mapping of the token vault 372 between card details and tokens.

The closed loop platform 350 identifies the prepaid card within the digital ledger 354 and updates the digital ledger 354 to indicate that the prepaid card is provisioned to the secure location 314. In some implementations, updating the digital ledger 354 to indicate that the prepaid card is provisioned includes disabling a physical instance of the prepaid card, such that the provisioned (i.e., digital) prepaid card can be used in transactions, but not the physical (i.e., plastic) instance of the prepaid card.

In some implementations, the provision rules engine 356 applies a set of rules for provisioning the prepaid card to determine whether the prepaid card can be provisioned. The set of rules can include fraud detection rules, where different fraud scores corresponding to different aspects of the prepaid card can be combined to generate an overall fraud score. The fraud scores can be generated using factors such as a time at which the provision request was made, a geolocation of the provision request, an entity requesting the token, a provision channel (e.g., app, web, wallet), a type of device making the provision request, an identity of an owner of the prepaid card, whether the owner of the prepaid card has been verified, a trustworthiness of the device making the provision request, and previous provision requests made by the device or the user. The provision rules engine 356 may also cause an identity of the user of the mobile device 310 to be verified. The identity of the user of the mobile device can be verified using challenge questions, identification documents, and/or multi-factor authentication.

In some implementations, the provision rules engine 356 checks whether the prepaid card is a first card for the mobile device 310 and the merchant. If the prepaid card is a first card for the merchant that is provisioned to the mobile device 310, the provision rules engine 356 causes the closed loop platform 350 to generate a new provisioning block for the prepaid card in the digital ledger 354. If the prepaid card is a second card for the merchant that is provisioned to the mobile device 310, the provision rules engine 356 causes the closed loop platform 350 to generate a sub-block of the original provisioning block for the first provisioned card in the digital ledger 354. In this way, the provision rules engine 356 can reduce a number of unique cards that are provisioned to the secure location 314 of the mobile device 310 to conserve space in the secure location 314. Instead of provisioning a new card to the secure location 314, the provision rules engine 356 can cause the closed loop platform 350 to generate a sub-block for the second-provisioned card of the provisioning block for the first-provisioned card, store a mapping of the PAN of the second-provisioned card to the token of the first-provisioned card in the mirror vault 352, and update an amount of the first-provisioned card at the mobile device 310. In this way, the mobile device 310 includes only one card per merchant, where subsequently-provisioned cards appear to update the balance of the cards originally provisioned to the secure location 314. In an example, instead of having six different prepaid cards for Merchant A provisioned to the secure location 314, the mobile device 310 has one card for Merchant A provisioned to the secure location 314, where the value of the one card is mapped, within the mirror vault 352 and the digital ledger 354, to the multiple different prepaid cards. In addition to preserving space in the secure location 314, traffic to and from the TSP 370 is reduced, preserving network bandwidth and increasing a speed of provisioning, rendering the provisioning process faster and more efficient.

In some implementations, when provisioning a second prepaid card for a merchant that already has a first prepaid card provisioned to the secure location 314 of the mobile device 310, the provision request is not sent to the wallet server 360 but is instead sent directly to the closed loop platform 350 by the merchant server 320. In an example, a user buys a prepaid gift card from a website of the merchant and requests provisioning to the secure location 314. In this example, the merchant server 320 sends the provision request to the closed loop platform 350 and, in response to determining, using the provision rules engine 356 that a prepaid card for the merchant is already provisioned to the secure location 314, the closed loop platform 350 maps the PAN of the prepaid gift card to the previously-provisioned token of the original prepaid card and updates a value in the digital ledger associated with the PAN of the original prepaid card. In this way, the PANs of the two prepaid cards are linked to the token of the original prepaid card, which token is stored in the secure location 314 of the mobile device 310.

While a single merchant server 320 is illustrated in the system 300, the closed loop platform 350 can aggregate prepaid cards for a plurality of merchants. The digital ledger 354 can include prepaid cards for the plurality of merchants, with cards aggregated by merchant-device pairings, as discussed herein. Thus, the mobile device 310 (and other mobile devices) can have multiple prepaid cards provisioned to the secure location 314 by the closed loop platform 350, where each provisioned card corresponds to a different merchant, and where each provisioned card can correspond to one or more purchased prepaid cards.

Prepaid cards and their corresponding tokens can experience life cycle changes due to events such as lost, stolen, or damaged devices, device upgrades, card updates, portfolio changes, BIN changes, or card metadata changes. These lifecycle events can trigger updates to tokens stored in the secure location 314 of the mobile device 310 and the corresponding PAN-to-token mapping in the mirror vault. The updates to the tokens and mapping can ensure synchronization across systems for accurate representation of the latest state. In some implementations, a user of the mobile device 310 indicates that a previous device was lost or stolen, causing the TSP 370 to generate a new token for the PAN of the prepaid card, and the new token is provisioned to the secure location 314 of the mobile device 310. In an example, a user identity is verified, the TSP 370 generates a new DPAN, the mappings of the new DPAN to the corresponding PAN are updated in the token vault 372 and the mirror vault 352, and the new DPAN is provisioned to the secure location 314 of the mobile device 314. In this example, once the new DPAN is provisioned to the secure location 314 and the mappings are updated, the prepaid card can be used for transactions as discussed herein. By tying the prepaid card to an identity of a user and allowing for re-provisioning of the prepaid card using a new token, the prepaid card can be recovered despite loss or theft of a device to which the prepaid card was originally provisioned.

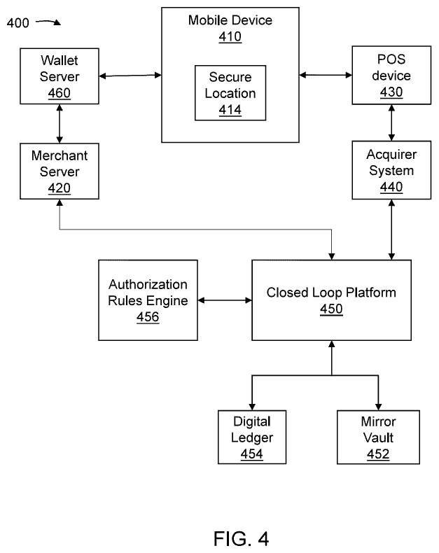

FIG. 4 is a block diagram of an example system 400 for executing transactions using prepaid cards that are provisioned to a secure location 414 in a mobile device 410. The system 400 includes a mobile device 410, a merchant server 420, a point-of-sale (POS) device 430, an acquirer system 440, a closed loop platform 450, a mirror vault 452, a digital ledger 454, an authorization rules engine 456, and a wallet server 460. In some implementations, the mirror vault 452, the digital ledger 454, and the authorization rules engine 456 are part of the closed loop platform 450. The system 400 operates to perform transaction conducted using a prepaid card (e.g., gift card) provisioned to the secure location 414 of the mobile device 410. The system 400 may be the same as the system 300, excluding the TSP 370 and the token vault 372, as they are not needed for execution of transactions using the prepaid card.

The mobile device 410 can initiate a transaction using a prepaid card provisioned to the secure location 414 at the POS device 430. The mobile device 410 can use its NFC antenna to transmit a token (e.g., DPAN) from the secure location 414 to the POS device 430. The POS device 430 transmits an authorization request including the token to the acquirer system 440. The acquirer system 440 identifies the closed loop platform 450 based on information in the authorization request and transmits the authorization request to the closed loop platform 450. In some implementations, the authorization request includes a bank identification number (BIN), an application provider identifier (AID), and/or a proprietary application identifier extension (PIX) associated with the closed loop platform 450. The acquirer system 440 transmits the authorization request to the closed loop platform 450. In some implementations, the acquirer system 440 transmits the authorization request to the merchant server 420 which transmits the authorization request to the closed loop platform 450.

The closed loop platform 450 detokenizes the token using the mirror vault 452 to obtain the PAN of the prepaid card. The mirror vault 452 stores a mapping of the token (e.g., DPAN) to the PAN of the prepaid card and detokenizes the token by returning the PAN in response to the token. The closed loop platform 450 queries the digital ledger using the PAN of the prepaid card to determine an amount of the prepaid card. The authorization rules engine 456 determines whether the prepaid card has sufficient funds for the authorization request and applies other authorization rules to determine whether to authorize the transaction. The authorization rules can include various fraud rules that take into account factors such as the factors used by the provision rules engine 356 of FIG. 3. The authorization rules engine 456 can include the provision rules engine 356 of FIG. 3, and can apply the provisioning rules and authorization rules as appropriate.

In response to the authorization request satisfying the authorization rules, the closed loop platform 450 transmits an approval to the acquirer system 440 which transmits the approval to the POS device 430 to complete the transaction. The closed loop platform 450 updates the digital ledger 454 based on an amount of funds of the prepaid card used in the transaction.

In some implementations, the transaction is initiated online or in an app of the merchant. The mobile device 410 can send an authorization request including the token of the prepaid card to the wallet server 460 which routes the authorization request to the merchant server 420. The merchant server 420 transmits the authorization request to the closed loop platform 450. Once the authorization request reaches the closed loop platform 450, the closed loop platform 450 detokenizes the token using the mapping between tokens and PANs stored in the mirror vault 452 and determines a value of the prepaid card using the associations between PANs and values in the digital ledger 454. Once the authorization rules engine 456 indicates approval of the transaction, the closed loop platform 450 transmits an approval to the merchant server 420 which routes the approval to the wallet server 460 to indicate approval of the transaction. The closed loop platform 450 updates the digital ledger 454 to reflect the changed value of the prepaid card after the transaction.

By using the mirror vault 452 to reference the mapping of tokens to PANs, instead of transmitting the token to a TSP and waiting for a response including the PAN, a speed of the detokenization is improved by 400-500% times (i.e., detokenization is 4-5 times faster), as detokenizing the token using the mirror vault 452 is much faster than sending the token to the TSP, waiting for the TSP to authenticate the closed loop platform 450, waiting for the TSP to authorize the request, waiting for the TSP to detokenize the token, and receiving the PAN from TSP.

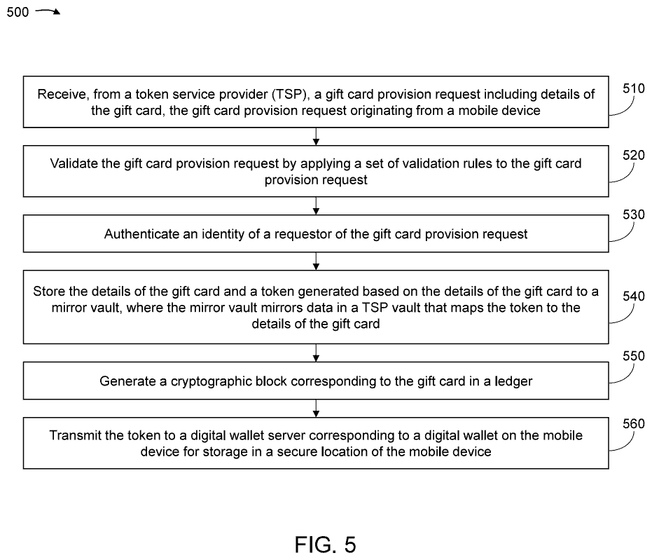

FIG. 5 is a flow diagram illustrating operations of an example method 500 for provisioning prepaid cards to a secure location in a mobile device. The method 500 can include more, fewer, or different operations than illustrated. One or more operations can be performed in the order shown, in a different order, or concurrently. The method 500 can be performed by one or more components of the system 300, such as the closed loop platform 350.

At operation 510, a gift card provision request is received from a TSP, the gift card provision request including details of the gift card, the gift card provision request originating from a mobile device. The gift card provision request can originate from a digital wallet of the mobile device, where the mobile device sends the provision request to a wallet server corresponding to the digital wallet in order to provision the gift card to a secure location of the digital wallet. The secure location can be implemented in hardware, software, or a combination of both. The details of the gift card include a PAN. The wallet server sends the PAN of the gift card to the TSP to tokenize the PAN. The TSP tokenizes the PAN and returns a token (e.g., DPAN) to the wallet server to provision the gift card upon approval for provisioning. The wallet server facilitates the storage of the token to the secure location of the digital wallet of the mobile device for use in transactions using the gift card.

At operation 520, the gift card provision request is validated by applying a set of validation rules to the gift card provision request. In some implementations, the set of validation rules are applied to the gift card provision request to generate a device score based on one or more of a time of the gift card provision request, a location of the gift card provision request, and a channel of the gift card provision request. The device score indicates a trustworthiness of the device, or a probability that the device is not making fraudulent requests. The channel of the gift card provision request can be a wallet channel (provision request originates from a wallet server) or a web request (provision request originates from a merchant web site) or from a mobile app.

At operation 530, an identity of a requestor of the gift card provision request is authenticated. In some implementations, the identity of the requestor is authenticated using challenge questions, identification documents, and/or multi-factor authentication. The identity of the requestor can be compared to one or more lists of prohibited individuals, such as global watchlists, sanctions lists, and money launderer blacklists. Once the identity of the user is authenticated, the provisioning of the gift card can be authorized or denied based on the identity of the user. The provisioned gift card can be linked to one or more markers of the user's identity, such as the user's name, address, phone number, email address, and other aspects of the user's identity.

At operation 540, details of the gift card and a token generated based on the details of the gift card are stored to a mirror vault, where the mirror vault mirrors data in a TSP vault that maps the token to the details of the gift card. The mirror vault can be directly accessed by the closed loop system, while the TSP vault is directly accessible only to the TSP. Thus, the mirror vault can be used instead of the TSP vault for detokenizing the token during transactions in order to more quickly and efficiently detokenize the token.

At operation 550, a cryptographic block corresponding to the gift card is generated in a ledger. In some implementations, the ledger is a blockchain ledger that is distributed across a plurality of nodes. Transactions executed using the gift card cause additional blocks to be added to the ledger that are linked to the block corresponding to the provisioning of the gift card. In this way, the source of funds (the provisioned gift card) is linked within the ledger to the use of the funds (the transactions).

At operation 560, the token is transmitted to a digital wallet server corresponding to a digital wallet on the mobile device for storage in a secure location of the mobile device. In some implementations, the gift card provision request is decomposed into component features and the component features are converted into application protocol data units (APDUs) for secure transmission to the digital wallet server along with the token to be stored in the secure location. The provision process may provide the details of the gift card in a format for use by a digital wallet on the mobile device to display a name, logo, and branding of the merchant, the value of the gift card, and any terms and conditions associated with the gift card.

In some implementations, the gift card details are decomposed into components and converted into the EVM data format for use by the closed loop platform. The converted data can be organized into data grouping identifiers with specific data and key groupings for conversion into the APDUs. The APDUs are encrypted using a combination of DES and AES encryption keys for transmission to the mobile device via the wallet server.

In some implementations, the method 500 includes storing details of an additional gift card to the mirror vault, where the mirror vault maps the details of the additional gift card to the token. In this way, the token is mapped within the mirror vault to the details of the original gift card and the additional gift card, allowing for transactions using the stored token to be performed using the value of the original gift card and/or the value of the additional gift card. In some implementations, the method 500 includes generating a token for a synthetic gift card based on the provisioned gift card and an additional gift card, where the mirror vault maps the token for the synthetic gift card to the details of the gift card and the additional gift card. The synthetic gift card can represent an aggregation of gift cards with the same merchant, allowing for use of the synthetic gift card, and a corresponding token, in all gift card transactions with the merchant.

In some implementations, the method 500 includes transmitting a notification of the provisioned gift card to a server of a merchant issuing the gift card. The merchant server or the closed loop platform can update a status of the gift card based on the gift card being provisioned to the secure location. In an example, the merchant server can cause a physical instance of the gift card to be deactivated based on the gift card being provisioned to the secure location.

The various messages (e.g., requests, responses, etc.) exchanged during the method 500 can be encrypted using a variety of encryption keys, such as data encryption standard (DES) and/or advanced encryption standard (AES) keys.

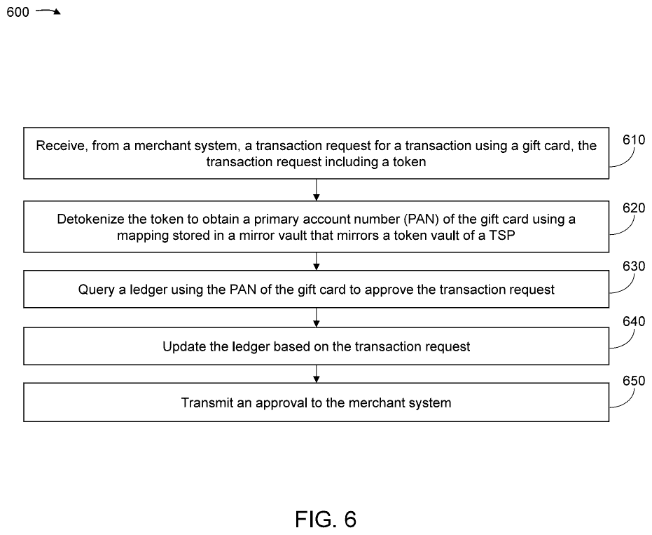

FIG. 6 is a flow diagram illustrating operations of an example method 600 for executing transactions using prepaid cards that are provisioned to a secure location in a mobile device. The method 600 can include more, fewer, or different operations than illustrated. One or more operations can be performed in the order shown, in a different order, or concurrently. The method 600 can be performed by one or more components of the system 400, such as the closed loop platform 450.

At operation 610, a transaction request is received from a merchant system (e.g., merchant server, merchant POS device) for a transaction using a gift card, the transaction request including a token (e.g., DPAN) corresponding to the gift card. In some implementations, the transaction request includes a bank identified number (BIN) associated with a closed loop system that processes transactions using the gift card. The transaction request can also include an application provider identifier (AID) and a propriety application identifier extension (PIX). The BIN, AID, and/or PIX indicate that the transaction request is to be routed to the closed loop system.

At operation 620, the token is detokenized to obtain a PAN of the gift card using a mapping stored in a mirror vault that mirrors a token vault of a TSP. The mirror vault can be directly accessed by the closed loop system, while the TSP vault is directly accessible only to the TSP. Thus, the mirror vault can be used instead of the TSP vault for detokenizing the token in order to more quickly and efficiently detokenize the token. Detokenizing the token includes querying the mapping to identify the PAN that is mapped to the token to return the PAN in response to the token.

At operation 630, a ledger is queried using the PAN of the gift card to approve the transaction request. Querying the ledger can include identifying a chain of one or more cryptographic blocks using the PAN to determine a current value of the gift card. The chain of one or more cryptographic blocks includes a provisioning block corresponding to a provisioning of the gift card. The chain of one or more cryptographic blocks can include transaction blocks corresponding to transactions performed using the provisioned gift card.

In some implementations, domain restrictions are applied. The mirror vault can restrict use of tokens to certain domains or use cases to enhance security. The mirror vault can also validate tokens using the token vault to ensure legitimacy of the tokens.

At operation 640, in response to the transaction being approved, the ledger is updated based on the transaction request. In some implementations, the ledger is a block chain ledger, and updating the ledger includes generating a cryptographic block corresponding to the transaction within the ledger. The cryptographic block corresponding to the transaction is linked within the ledger to the provisioning block corresponding to provisioning of the gift card. The transaction block can be linked to the provisioning block in the chain of one or more cryptographic blocks. By traversing the chain of one or more cryptographic blocks, including the transaction block for the current transaction, a current value of the gift card can be determined, as well as a history (provisioning and transaction history) of the gift card.

The chain of one or more transactions can be used to re-provision a gift card in response to a lost or stolen device. Upon authenticating an identity of a user, a new token can be generated and mapped to the PAN of the gift card so that the new token can be stored in the secure location of the user's device (e.g., new device). Linking the gift card to the user's identity and providing the ability to restore the gift card represents a distinct advantage over conventional gift cards that can be used by anyone and which cannot be recovered once stolen. Additionally, a token in the mirror vault can be mapped to another token, can be used to provision a single mapped gift card to another device of the user, allowing for cross-device or cross-platform provisioning. In an example, gift card can be provisioned on a user's iOS device and the user's Android device.

At operation 650, in response to the transaction being approved, an approval is transmitted to the merchant system. The merchant system can cause the transaction to be completed in response to the approval. By routing the transaction through the merchant system and the closed loop system, the transaction can be performed without accessing any third-party payment networks.

In some implementations, the transaction is routed from the mobile device to a wallet server that transmits the authorization request to an acquirer system. The acquirer system can be a bank of the merchant. The acquirer system, based on the authorization request, routes the authorization request to the closed loop system for processing of the transaction. In this way, the closed loop system can process transactions that originate through various different channels.

In some implementations, the mirror vault maps multiple PANs of multiple gift cards to a single token. This may be done to limit a number of cards provisioned to the secure location in order to conserve space in the secure location. The multiple gift cards can be gift cards for the same merchant, where the mirror vault maps the PANs of the multiple gift cards to the token located in the secure element such that the values of the multiple gift cards can be used in transactions using the token. In an example, querying the ledger includes querying the amount associated with each PAN that is mapped to the token in order to compare a total amount of all of the gift cards to the authorization request. In response to approving the transaction, a subset of the values of the multiple gift cards (or of all the multiple gift cards) is updated based on the transaction. In this way, the same token stored in the secure element can be used for multiple different transactions using values associated with multiple different gift cards.

### Non-Limiting Examples

In an example, a person receives a gift card and scans the gift card with their mobile phone to add the gift card to their mobile wallet. The mobile phone sends the PAN of the gift card to a wallet server of the mobile wallet which sends the PAN to a TSP to tokenize. The TSP generates a DPAN for the PAN, stores a mapping of the DPAN to the PAN in its token vault, and sends the DPAN and PAN to a closed loop system. The closed loop system stores a mapping of the DPAN to the PAN to its mirror vault, which verifies that the mapping matches the mapping in the token vault. The closed loop system verifies that the PAN is represented in its digital ledger and that the PAN is activated for use, and generates a provisioning block in the ledger corresponding to the provisioning of the gift card to the mobile phone. The closed loop system indicates to the TSP that the gift card can be provisioned and the TSP returns the DPAN to the wallet server and the wallet server stores the DPAN in a secure element of the mobile phone. The person uses the digital wallet in an eCommerce or NFC transaction, causing a transaction request to go to the acquiring server, which routes the transaction request to the closed loop system. The closed loop system queries its ledger to approve the transaction, generates a transaction block in the ledger corresponding to the transaction, and sends an approval to the acquiring server to complete the transaction. The person then receives a text message on the mobile phone from a friend to receive another gift card to the same merchant as the original gift card. The person clicks on a link in the text message, which takes the person to a site where the person enters identifying information. Based on identifying the person, and determining that the person has already provisioned a gift card for the merchant to the secure element of the mobile phone, the closed loop system generates another provisioning block for the new gift card as a sub-block of the original provisioning block and adds a mapping to the mirror vault to map the new gift card to the token stored in the secure element of the mobile phone. The person then goes to the merchant's website and performs a transaction. The merchant server sends a transaction request including the token to the closed loop system which queries the mirror vault using the token to identify the PANs of the two gift cards, and then queries the ledger to determine the values of the two gift cards. The closed loop system updates the value of the first gift card to be zero and the value of the second gift card to be lower based on the transaction exceeding the value of the first gift card, but not the value of the two gift cards together. The closed loop system sends an approval to the merchant server to complete the transaction.

Example 1: A system comprising: one or more processors; and a non-transitory, computer-readable medium including instructions which, when executed by the one or more processors, cause the one or more processors to: receive, from a token service provider (TSP), a gift card provision request including details of the gift card, the gift card provision request originating from a mobile device; validate the gift card provision request by applying a set of validation rules to the gift card provision request; authenticate an identity of a requestor of the gift card provision request; store the details of the gift card and a token generated based on the details of the gift card to a mirror vault, wherein the mirror vault mirrors data in a TSP vault that maps the token to the details of the gift card; generate a cryptographic block corresponding to the gift card in a ledger; and transmit the token to a digital wallet server corresponding to a digital wallet on the mobile device for storage in a secure location of the mobile device.

Example 2: The system of example 1, wherein the instructions cause the one or more processors to store details of an additional gift card to the mirror vault, wherein the mirror vault maps the details of the additional gift card to the token.

Example 3: The system of example 1, wherein the instructions cause the one or more processors to generate a token for a synthetic gift card based on the provisioned gift card and an additional gift card, wherein the mirror vault maps the token for the synthetic gift cad to the details of the gift card and the additional gift card.

Example 4: The system of example 1, wherein the instructions cause the one or more processors to apply the set of validation rules to the gift card provision request to generate a device score based on one or more of a time of the gift card provision request, a location of the gift card provision request, and a channel of the gift card provision request.

Example 5: The system of example 1, wherein the instructions cause the one or more processors to authorize the requestor of the gift card provision request by comparing the identity of the requestor to a list of prohibited individuals, devices or accounts.

Example 6: The system of example 1, wherein the ledger is distributed across a plurality of nodes.

Example 7: The system of example 1, wherein the instructions cause the one or more processors to: decompose the gift card provision request into component features; and convert the component features into application protocol data units for transmission to the digital wallet server along with the token.

Example 8: The system of example 1, wherein the instructions cause the one or more processors to transmit a notification of the provisioned gift card to a server of a merchant issuing the gift card.

Example 9: A computer-implemented method comprising: receiving, by one or more processors, from a token service provider (TSP), a gift card provision request including details of the gift card, the gift card provision request originating from a mobile device; validating, by the one or more processors, the gift card provision request by applying a set of validation rules to the gift card provision request; authenticating, by the one or more processors, an identity of a requestor of the gift card provision request; storing, by the one or more processors, the details of the gift card and a token generated based on the details of the gift card to a mirror vault, wherein the mirror vault mirrors data in a TSP vault that maps the token to the details of the gift card; generating, by the one or more processors, a cryptographic block corresponding to the gift card in a ledger; and transmitting, by the one or more processors, the token to a digital wallet server corresponding to a digital wallet on the mobile device for storage in a secure location of the mobile device.

Example 10: The computer-implemented method of example 9, further comprising storing, by the one or more processors, details of an additional gift card to the mirror vault, wherein the mirror vault maps the details of the additional gift card to the token.

Example 11: The computer-implemented method of example 9, further comprising generating, by the one or more processors, a token for a synthetic gift card based on the provisioned gift card, wherein the mirror vault maps the details of the gift card and details of an additional gift card to the token for the synthetic gift card.

Example 12: The computer-implemented method of example 9, further comprising applying, by the one or more processors, the set of validation rules to the gift card provision request to generate a device score based on one or more of a time of the gift card provision request, a location of the gift card provision request, and a channel of the gift card provision request.

Example 13: The computer-implemented method of example 9, further comprising authorizing, by the one or more processors, the requestor of the gift card provision request by comparing the identity of the requestor to a list of prohibited individuals.

Example 14: The computer-implemented method of example 9, wherein the ledger is distributed across a plurality of nodes.

Example 15: The computer-implemented method of example 9, further comprising: decomposing, by the one or more processors, the gift card provision request into component features; and converting, by the one or more processors, the component features into application protocol data units for transmission to the digital wallet server along with the token.

Example 16: The computer-implemented method of example 9, further comprising transmitting, by the one or more processors, a notification of the provisioned gift card to a server of a merchant issuing the gift card.

Example 17: A system comprising: one or more processors; and a non-transitory, computer-readable medium including instructions which, when executed by the one or more processors, cause the one or more processors to: receive, from a merchant system, a transaction request for a transaction using a gift card, the transaction request including a token; detokenize the token to obtain a primary account number (PAN) of the gift card using a mapping stored in a mirror vault, wherein the mirror vault mirrors a token vault of the TSP; query a ledger using the PAN of the gift card to approve the transaction request; and in response to approving the transaction request: update the ledger based on the transaction request; transmit an approval to the merchant system.

Example 18: The system of example 17, wherein the transaction request includes a bank identification number (BIN) associated with the system.

Example 19: The system of example 17, wherein the instructions cause the one or more processors to update the ledger by generating a cryptographic block corresponding to the transaction within the ledger.

Example 20: The system of example 19, wherein the cryptographic block corresponding to the transaction is linked within the ledger to a provisioning block corresponding to provisioning of the gift card.

### Additional Considerations

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A system comprising:
one or more processors; and
a non-transitory, computer-readable medium including instructions which, when executed by the one or more processors, cause the one or more processors to:
receive, from a token service provider (TSP), a gift card provision request including details of a gift card, the gift card provision request originating from a mobile device;
validate the gift card provision request by applying a set of validation rules to the gift card provision request;
authenticate an identity of a requestor of the gift card provision request;
store the details of the gift card and a token generated based on the details of the gift card to a mirror vault, wherein the mirror vault mirrors data in a TSP vault that maps the token to the details of the gift card;
generate a cryptographic block corresponding to the gift card in a ledger; and
transmit the token to a digital wallet server corresponding to a digital wallet on the mobile device for storage in a secure location of the mobile device.

2. The system of claim 1, wherein the instructions cause the one or more processors to store details of an additional gift card to the mirror vault, wherein the mirror vault maps the details of the additional gift card to the token.

3. The system of claim 1, wherein the instructions cause the one or more processors to generate a token for a synthetic gift card based on the provisioned gift card and an additional gift card, wherein the mirror vault maps the token for the synthetic gift card to the details of the gift card and the additional gift card.

4. The system of claim 1, wherein the instructions cause the one or more processors to apply the set of validation rules to the gift card provision request to generate a device score based on one or more of a time of the gift card provision request, a location of the gift card provision request, and a channel of the gift card provision request.

5. The system of claim 1, wherein the instructions cause the one or more processors to authorize the requestor of the gift card provision request by comparing the identity of the requestor to a list of prohibited individuals, devices or accounts.

6. The system of claim 1, wherein the ledger is distributed across a plurality of nodes.

7. The system of claim 1, wherein the instructions cause the one or more processors to:
decompose the gift card provision request into component features; and
convert the component features into application protocol data units for transmission to the digital wallet server along with the token.

8. The system of claim 1, wherein the instructions cause the one or more processors to transmit a notification of the provisioned gift card to a server of a merchant issuing the gift card.

9. A computer-implemented method comprising:
receiving, by one or more processors, from a token service provider (TSP), a gift card provision request including details of the gift card, the gift card provision request originating from a mobile device;
validating, by the one or more processors, the gift card provision request by applying a set of validation rules to the gift card provision request;
authenticating, by the one or more processors, an identity of a requestor of the gift card provision request;
storing, by the one or more processors, the details of the gift card and a token generated based on the details of the gift card to a mirror vault, wherein the mirror vault mirrors data in a TSP vault that maps the token to the details of the gift card;
generating, by the one or more processors, a cryptographic block corresponding to the gift card in a ledger; and
transmitting, by the one or more processors, the token to a digital wallet server corresponding to a digital wallet on the mobile device for storage in a secure location of the mobile device.

10. The computer-implemented method of claim 9, further comprising storing, by the one or more processors, details of an additional gift card to the mirror vault, wherein the mirror vault maps the details of the additional gift card to the token.

11. The computer-implemented method of claim 9, further comprising generating, by the one or more processors, a token for a synthetic gift card based on the provisioned gift card, wherein the mirror vault maps the details of the gift card and details of an additional gift card to the token for the synthetic gift card.

12. The computer-implemented method of claim 9, further comprising applying, by the one or more processors, the set of validation rules to the gift card provision request to generate a device score based on one or more of a time of the gift card provision request, a location of the gift card provision request, and a channel of the gift card provision request.

13. The computer-implemented method of claim 9, further comprising authorizing, by the one or more processors, the requestor of the gift card provision request by comparing the identity of the requestor to a list of prohibited individuals.

14. The computer-implemented method of claim 9, wherein the ledger is distributed across a plurality of nodes.

15. The computer-implemented method of claim 9, further comprising:
decomposing, by the one or more processors, the gift card provision request into component features; and
converting, by the one or more processors, the component features into application protocol data units for transmission to the digital wallet server along with the token.

16. The computer-implemented method of claim 9, further comprising transmitting, by the one or more processors, a notification of the provisioned gift card to a server of a merchant issuing the gift card.

17. A system comprising:
one or more processors; and
a non-transitory, computer-readable medium including instructions which, when executed by the one or more processors, cause the one or more processors to:
receive, from a merchant system, a transaction request for a transaction using a gift card, the transaction request including a token;
detokenize the token to obtain a primary account number (PAN) of the gift card using a mapping stored in a mirror vault, wherein the mirror vault mirrors a token vault of a token service provider (TSP);
query a ledger using the PAN of the gift card to approve the transaction request; and
in response to approving the transaction request:
update the ledger based on the transaction request; and
transmit an approval to the merchant system.

18. The system of claim 17, wherein the transaction request includes a bank identification number (BIN) associated with the system.

19. The system of claim 17, wherein the instructions cause the one or more processors to update the ledger by generating a cryptographic block corresponding to the transaction within the ledger.

20. The system of claim 19, wherein the cryptographic block corresponding to the transaction is linked within the ledger to a provisioning block corresponding to provisioning of the gift card.
